(19) United States
(12) Patent Application Publication
(10) Pub. No.: US 2026/0021669 A1
(43) Pub. Date: Jan. 22, 2026

(54) PRINTING APPARATUS

(71) Applicant: BROTHER KOGYO KABUSHIKI KAISHA, Nagoya (JP)

(72) Inventors: Yuta ARAKAWA, Nagoya (JP); Hiroaki TAKAHASHI, Nagoya (JP)

(73) Assignee: BROTHER KOGYO KABUSHIKI KAISHA, Nagoya (JP)

(21) Appl. No.: 19/268,472

(22) Filed: Jul. 14, 2025

(30) Foreign Application Priority Data
Jul. 16, 2024 (JP) 2014-113514
Jul. 16, 2024 (JP) 2024-113513

(51) Int. Cl. B41J 13/16; B41J 11/00; B41J 13/03; B41J 13/10; B41J 29/02

(52) U.S. Cl. CPC B41J 13/16; B41J 11/006; B41J 13/03; B41J 13/103; B41J 29/02

(57) ABSTRACT

A printing apparatus includes a housing, a first conveyance-path guide, a second conveyance-path guide, and a slider. The first conveyance-path guide is disposed in the housing. The first conveyance-path guide includes a first guide surface defining a first conveyance path. The second conveyance-path guide is disposed in the housing. The second conveyance-path guide includes a second guide surface defining a second conveyance path. The slider is disposed in the housing. The slider is movable between a first position and a second position. At the first position, the slider contacts and positions each of the first conveyance-path guide and the second conveyance-path guide. At the second position, the slider separates from the first conveyance-path guide and the second conveyance-path guide, and releases positioning of the first conveyance-path guide and the second conveyance-path guide.

### REFERENCE TO RELATED APPLICATIONS

This application claims priority from Japanese Patent Application Nos. 2024-113513 and 2024-113514 both filed on Jul. 16, 2024. The entire content of each of the priority applications is incorporated herein by reference.

### BACKGROUND ART

A printing apparatus that prints an image on a sheet is known.

### SUMMARY

A printing apparatus conveys a sheet to a printing area between a print head and a platen, and prints an image. A platen support member is disposed below the platen. The platen and the platen support member are separate members that open and close independently. When the platen and the platen support member are opened, jam removal processing of the sheet jammed in the printing area is performed.

A reverse path for reversing the sheet is located between the platen support member and a jam processing cover disposed on a side surface of the printing apparatus. The platen support member includes a conveyance roller that conveys the sheet in the reverse path. In conjunction with the closing of the platen support member, the platen and the conveyance roller are positioned. Since the platen support member pivots about a vertical axis when closed, a large work space is used, and the platen support member is not suitable for a small apparatus. In the jam removal processing, the user pushes a button disposed on a side surface of the apparatus to open the jam processing cover and manually open the platen support member to access the platen, which makes the operation troublesome.

In view of the foregoing, an example of an object of this disclosure is to save a work space used for positioning of a platen and positioning of a conveyance roller in a printing apparatus. Another example of an object of this disclosure is to open a platen with a simple operation and accurately position the platen at a particular position in a printing apparatus.

According to one aspect, this specification discloses a printing apparatus. The printing apparatus includes a housing, a first conveyance-path guide, a second conveyance-path guide, and a slider. The first conveyance-path guide is disposed in the housing. The first conveyance-path guide includes a first guide surface defining a first conveyance path. The second conveyance-path guide is disposed in the housing. The second conveyance-path guide includes a second guide surface defining a second conveyance path. The slider is disposed in the housing. The slider is movable between a first position and a second position. At the first position, the slider contacts and positions each of the first conveyance-path guide and the second conveyance-path guide. At the second position, the slider separates from the first conveyance-path guide and the second conveyance-path guide, and releases positioning of the first conveyance-path guide and the second conveyance-path guide.

With the above configuration, the printing apparatus saves a work space for positioning of a platen and positioning of a conveyance roller.

According to another aspect, this specification also discloses a printing apparatus. The printing apparatus includes a first guide. The first guide includes a first conveyance-path guide and a second conveyance-path guide. The first conveyance-path guide includes a first guide surface defining a first conveyance path. The second conveyance-path guide is configured to receive pressure from another member. The first guide being movable between a guide position and a non-guide position. At the guide position, the first guide guides a sheet conveyed along the first conveyance path by the first guide surface. At the non-guide position, the first guide is moved from the guide position. In a state where the first guide is located at the guide position, each of the first conveyance-path guide and the second conveyance-path guide is positioned.

With the above configuration, the printing apparatus is opened by a simple operation, and a platen is accurately positioned at a particular position.

### BRIEF DESCRIPTION OF DRAWINGS

FIG. 1 is an external perspective view of a multifunction peripheral (MFP) 10.

FIG. 2 is a vertical cross-sectional view showing a printer unit 11 to which a feed tray 20 is attached.

FIG. 3 is an external perspective view of a platen 201.

FIG. 4 is a diagram showing a clearance 209 between a first conveyance-path guide 42 and a pressure receiving member 55.

FIG. 5 is a perspective view showing the inside of the printer unit 11.

FIG. 6 is an external perspective view of the pressure receiving member 55.

FIG. 7 is a top view showing the inside of the printer unit 11.

FIG. 8 is a top view showing the inside of the printer unit 11 from which the first conveyance-path guide 42 is removed.

FIG. 9A is an external perspective view of a side frame 53.

FIG. 9B is an inner side view of the side frame 53.

FIG. 10A is an external perspective view of a left slider 103.

FIG. 10B is an inner side view of the left slider 103.

FIG. 10C is an outer side view of the left slider 103.

FIG. 11A is an external perspective view of the feed tray 20.

FIG. 11B is an inner side view of a left side wall of the feed tray 20.

FIG. 12 is a vertical cross-sectional view showing the printer unit 11 from which the feed tray 20 is removed.

FIG. 13A is an inner side view of the side frame 53 and the slider 103 to which the feed tray 20 is attached.

FIG. 13B is an inner side view of the side frame 53 and the slider 103 from which the feed tray 20 is detached.

FIG. 13C is an outer side view of the side frame 53 and the slider 103 from which the feed tray 20 is detached.

FIG. 14 is a vertical cross-sectional view showing a positioning state of the first conveyance-path guide 42 and the pressure receiving member 55.

FIG. 15 is a vertical cross-sectional view of the printer unit 11 in a state where a first conveyance path 65 is opened.

FIG. 16 is an external perspective view of a second guide 74.

FIG. 17 is a vertical cross-sectional view showing the first conveyance-path guide 42 and the pressure receiving member 55, which are released from the positioning.

FIG. 18 is a vertical cross-sectional view of the printer unit 11 in a state where a second conveyance path 71 opened.

FIG. 19A is a schematic view showing a plain paper 227, corrugated members 208, and the platen 201.

FIG. 19B is a schematic view showing a thick paper 228, the corrugated members 208, and the platen 201.

### DESCRIPTION

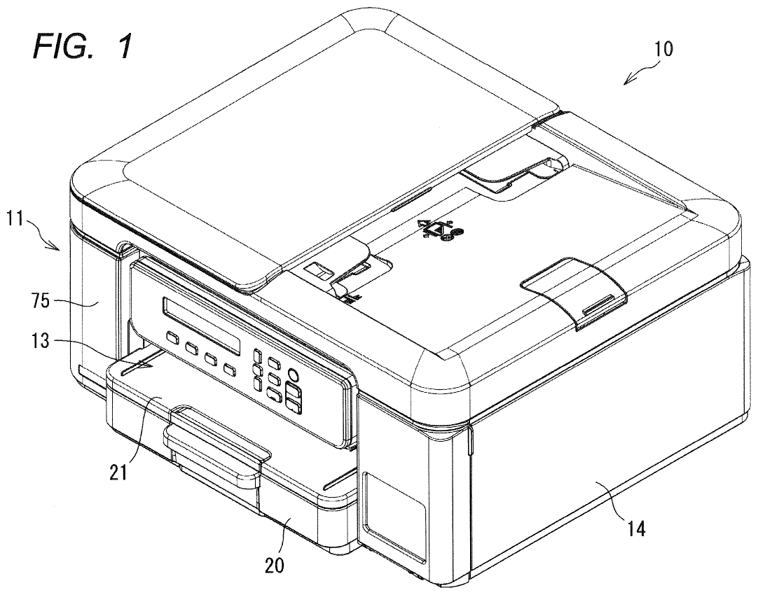

Hereinafter, a printing apparatus according to an embodiment of the present disclosure will be described in detail. The following embodiment is merely an example of the present disclosure, and the embodiment of the present disclosure may be appropriately modified within a range not changing the gist of the present disclosure. An upper-lower direction is defined with reference to a state where a multifunction peripheral (MFP) 10 according to the embodiment of the printing apparatus according to the present disclosure is installed on a horizontal surface so as to be usable. This is the posture in FIG. 1, and may be referred to as “use posture”. A front-rear direction is defined with a side of the MFP 10 on which an opening 13 is formed as a front side. A left-right direction is defined when the MFP 10 is viewed from the front side. In the present embodiment, in the use posture, the upper-lower direction corresponds to a vertical direction, the front-rear direction and the left-right direction correspond to a horizontal direction, and the front-rear direction and the left-right direction are perpendicular to each other. The front side is also referred to as a front surface side, and the rear side is also referred to as a rear surface side.

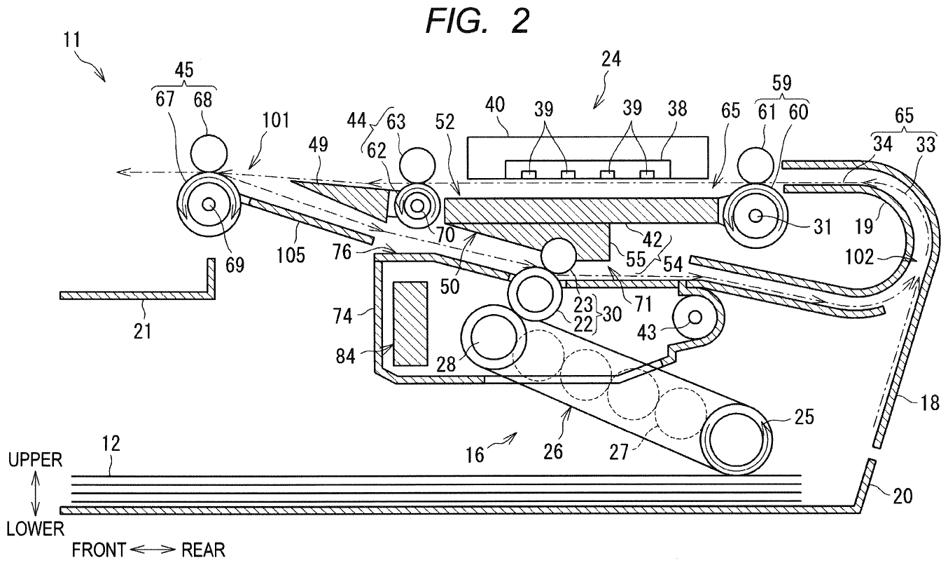

An overall configuration of the MFP 10 will be described. As shown in FIGS. 1 and 2, the MFP 10, which is an example of a printing apparatus according to the present disclosure, has a printing function and other functions. The MFP 10 has a substantially rectangular parallelepiped shape. The MFP 10 includes a printer unit 11 that prints an image on a sheet by an inkjet printing method in a lower portion of the MFP 10. Hereinafter, the sheet is referred to as a sheet (printing sheet) 12.

The printer unit 11 includes a housing 14. The housing 14 has an opening 13 on the front surface. The feed tray 20 is attachable to and detachable from the printer unit 11 by moving the feed tray 20 in the front-rear direction with respect to the opening 13. The feed tray 20 accommodates the sheet 12 used for printing. As shown in FIGS. 2, 7, and 8, the housing 14 accommodates a feeder 16, a print engine 24, a first guide 54, a second guide 74, a slider 103, a first conveyance path 65, a second conveyance path 71, and a frame. Hereinafter, the frame is referred to as a side frame 53. In FIG. 2, the arrows of the single-dot chain lines indicate the conveyance path and a conveyance direction of the sheet 12 (hereinafter, simply referred to as “conveyance direction”).

The feeder 16 includes a feed roller 25, a feed arm 26, a drive transmission mechanism 27, and a support shaft 28. The feed arm 26 is an elongated member, and has the support shaft 28 at one end in the longitudinal direction and the feed roller 25 at the other end. The feed arm 26 is pivotable about the support shaft 28 relative to the second guide 74. The feed arm 26 includes the drive transmission mechanism 27. The drive transmission mechanism 27 transmits rotational driving force of a drive roller of the second guide 74 to the feed roller 25. Hereinafter, the drive roller is referred to as a re-conveyance roller 22. When the feed arm 26 pivots by its own weight and hangs down from the second guide 74, the feed roller 25 contacts the uppermost sheet 12. When the drive transmission mechanism 27 transmits the rotational driving force of the re-conveyance roller 22 to the feed roller 25, the feed roller 25 feeds the sheets 12 one sheet at a time.

The first conveyance path 65 is defined by an outer guide member 18, an inner guide member 19, the print engine 24, the first guide 54, and a flap 49. The outer guide member 18 and the inner guide member 19 define a curved portion 33. The curved portion 33 extends upward at the rear portion of the printer unit 11 and makes a U-turn forward. The curved portion 33 guides the sheet 12 fed by the feed roller 25 to a conveyance roller 60. The lower surface of the print engine 24, in other words, a nozzle surface of a print head 38 defines the first conveyance path 65 from above. A first guide surface 52 of the first guide 54 defines the first conveyance path 65 from below. The flap 49 is pivotable about a pivot shaft of a discharge roller 62. An end portion of the flap 49 on the pivot shaft side is referred to as a base end, and the other end is referred to as a tip end. In the first conveyance path 65, the feed roller 25, the conveyance roller 60, a conveyance pinch roller 61, the discharge roller 62, a discharge spur roller 63, a reverse roller 67, and a reverse spur roller 68 are arranged along the conveyance direction, and rotate in the conveyance direction during printing.

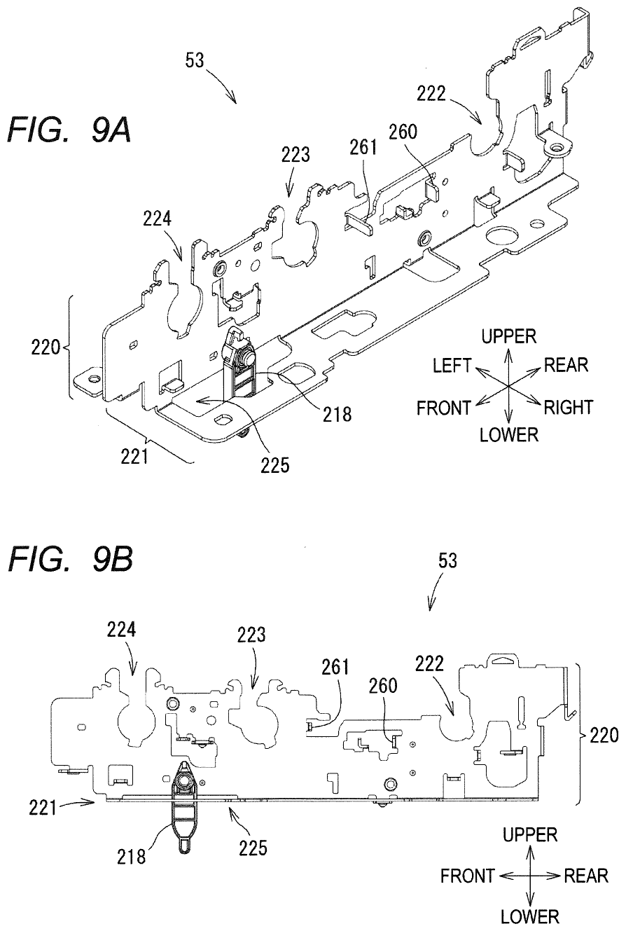

The conveyance roller 60 rotates about a first pivot shaft 31. The first pivot shaft 31 is pivotally supported by a conveyance roller bearing 210. As shown in FIGS. 9A and 9B, the side frame 53 has a first cutout 222, a second cutout 223, and a third cutout 224. The outer portions of the left and right rear portions of the conveyance roller bearing 210 are fitted into the first cutout 222. The inner portion of the conveyance roller bearing 210 protrudes to inside of the side frame 53. The conveyance pinch roller 61 is pressed against the conveyance roller 60 to form a conveyance nip, and is rotated by following rotation of the conveyance roller 60. The discharge roller 62 rotates about a discharge roller shaft 70. The discharge roller shaft 70 is supported by a discharge roller bearing 211. The discharge roller bearing 211 is fitted into the second cutout 223. The discharge spur roller 63 is pressed against the discharge roller 62 to form a conveyance nip, and is rotated by following rotation of the discharge roller 62. The reverse roller 67 is rotatable about a reverse roller shaft 69. A reverse roller bearing 212 is fitted to the reverse roller shaft 69. The reverse spur roller 68 is pressed against the reverse roller 67 to form a conveyance nip, and is rotated by following rotation of the reverse roller 67. The sheet 12 is conveyed while being nipped by the conveyance nips. The flap 49 pivots so as to lower the tip end thereof, and guides the sheet 12 from the discharge roller 62 to the reverse roller 67. When an image is printed on one surface of the sheet 12, the reverse roller 67 conveys the sheet 12 to a discharge tray 21.

The second conveyance path 71 is defined by the flap 49, a third guide member 105, the first guide 54, and the second guide 74. The flap 49 and a second guide surface 50 of the first guide 54 define the second conveyance path 71 from above. The third guide member 105 and a third guide surface 76 of the second guide 74 define the second conveyance path 71 from below. Along the second conveyance path 71, the reverse roller 67, the reverse spur roller 68, the re-conveyance roller 22, and a pinch roller 23 are arranged in the conveyance direction. When an image is printed on the back surface of the sheet 12 in addition to the front surface thereof, the reverse roller 67 first conveys the sheet 12 until the trailing end of the sheet 12 passes the flap 49. Next, the flap 49 pivots so as to lift the leading end, and then the reverse roller 67 reverses the conveyance direction to convey the sheet 12. The flap 49 and the third guide member 105 guide the sheet 12 toward the re-conveyance roller 22. The second conveyance path 71 extending from the reverse roller 67 toward the re-conveyance roller 22 branches off at a branch position 101 from the first conveyance path 65 extending from the discharge roller 62 toward the reverse roller 67.

The re-conveyance roller 22 is disposed at the second guide 74, and the pinch roller 23 is disposed at the first guide 54. The pinch roller 23 is pressed against the re-conveyance roller 22 to form a conveyance nip, and is rotated by following rotation of the re-conveyance roller 22. The re-conveyance roller 22 conveys the sheet 12 while nipping the sheet 12 in the conveyance nip. The second conveyance path 71 merges with the first conveyance path 65 at a merging position 102. Accordingly, the sheet 12 conveyed to the merging position 102 via the second conveyance path 71 enters the first conveyance path 65 at the merging position 102 and is guided to the conveyance roller 60. Thereafter, an image is printed on the back surface of the sheet 12 in the same manner as an image is printed on the front surface of the sheet 12, and the sheet 12 is discharged to the discharge tray 21 via the discharge roller 62 and the reverse roller 67.

The print engine 24 is disposed above the first conveyance path 65 at a position downstream of the conveyance roller 60 and upstream of the discharge roller 62 in the conveyance direction. The print engine 24 faces the first guide 54 from above with the first conveyance path 65 interposed therebetween. The print engine 24 includes a carriage 40 and the print head 38. The carriage 40 is supported by two guide rails (not shown) arranged with a space therebetween in the front-rear direction so as to reciprocate in the left-right direction. The print head 38 is mounted on the carriage 40. The lower surface of the print head 38 is the nozzle surface on which a plurality of nozzles are formed. The plurality of nozzles form a plurality of nozzle rows, and a plurality of nozzles are arranged in each nozzle row. The nozzle surface faces the first conveyance path 65, and thus faces a print surface of the sheet 12. The print head 38 receives ink supplied from an ink cartridge (not shown) and ejects ink of each color of black, magenta, cyan, and yellow from the nozzle surface. When the carriage 40 is moving in the left-right direction, the print head 38 ejects ink droplets from nozzles 39, so that a color image is printed on the sheet 12 supported by the first guide 54.

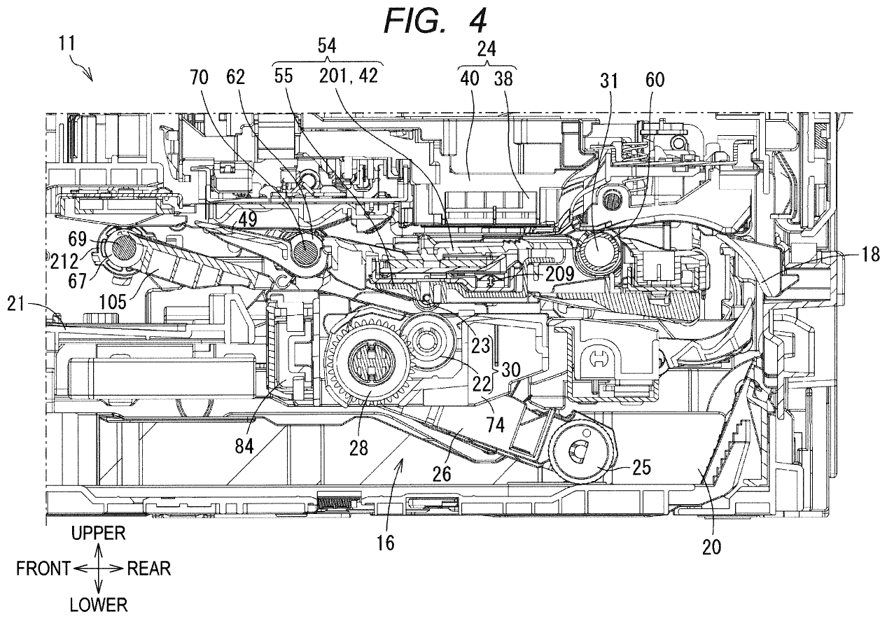

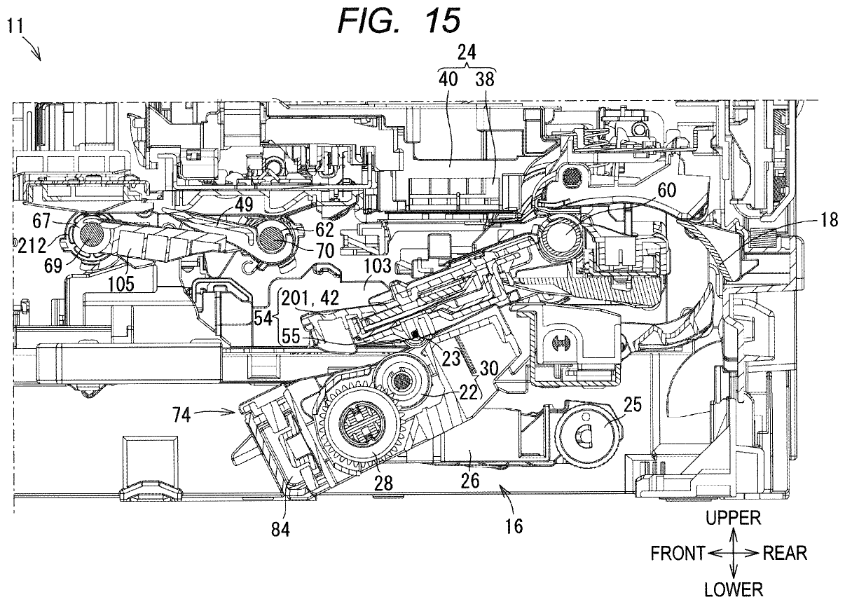

The first guide 54 is assembled from a first conveyance-path guide (first conveyance-path forming member) 42 and a second conveyance-path guide (second conveyance-path forming member). Hereinafter, the second conveyance-path guide is referred to as a pressure receiving member 55. The first conveyance-path guide 42 has the first guide surface 52 that defines the first conveyance path 65. The first guide 54 is movable between a third position (guide position) (see FIG. 4) at which the sheet 12 conveyed in the first conveyance path 65 is guided by the first guide surface 52 and a fourth position (non-guide position) (see FIG. 15) at which the first guide 54 is moved downward from the third position. When the first guide 54 is located at the third position, each of the first conveyance-path guide 42 and the pressure receiving member 55 is positioned (more specifically, each of the first conveyance-path guide 42 and the pressure receiving member 55 is positioned with respect to the housing 14).

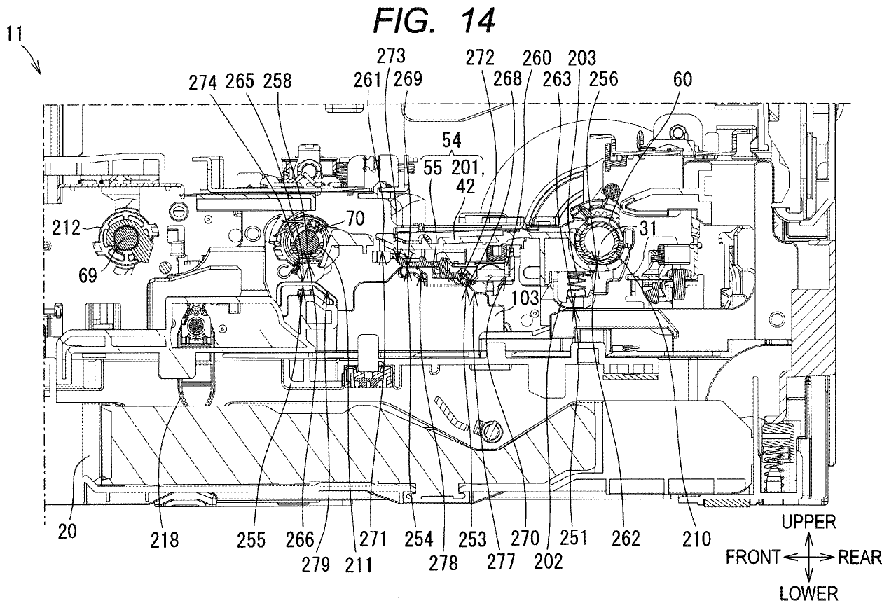

As shown in FIG. 14, the first conveyance-path guide 42 includes a first member, a second member, and a third member. Hereinafter, the first member is referred to as a platen 201. The second member is referred to as a platen movable member 202. The third member is referred to as a platen elastic member 203.

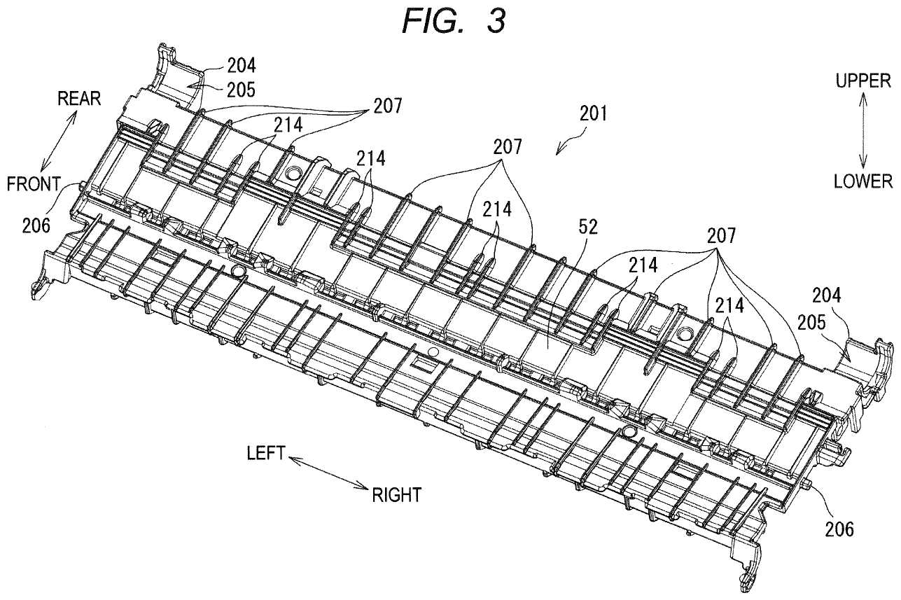

As shown in FIG. 3, the platen 201 is a flat plate member having a substantially rectangular shape elongated in the left-right direction in a top view. The platen 201 includes the first guide surface 52, a pair of platen rear protrusions 204, and a pair of platen side protrusions 206. The first guide surface 52 defines a head gap, which is a distance between the sheet 12 and the nozzle surface, which is a lower surface of the print head 38. Accordingly, the print head 38 causes the ink ejected from the nozzle surface to land on a desired position on the sheet 12.

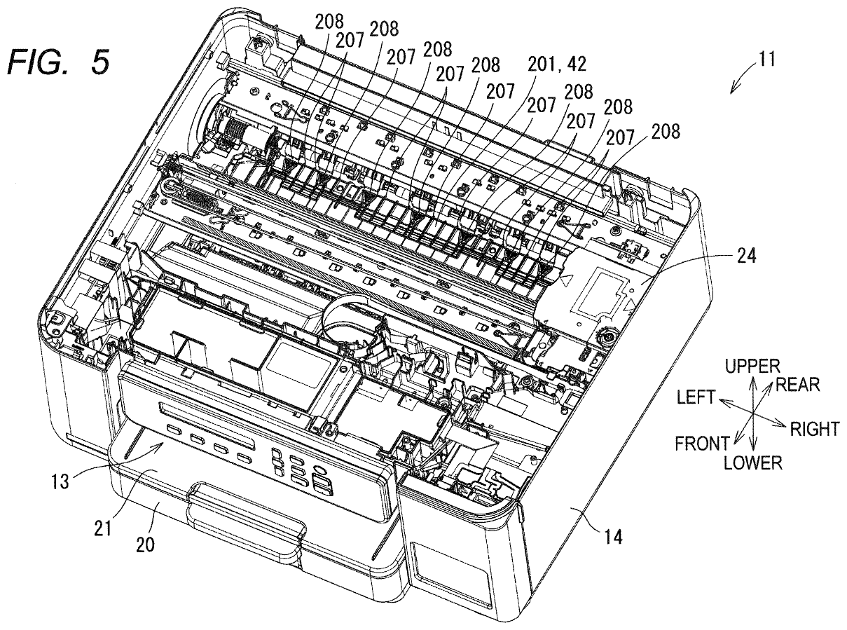

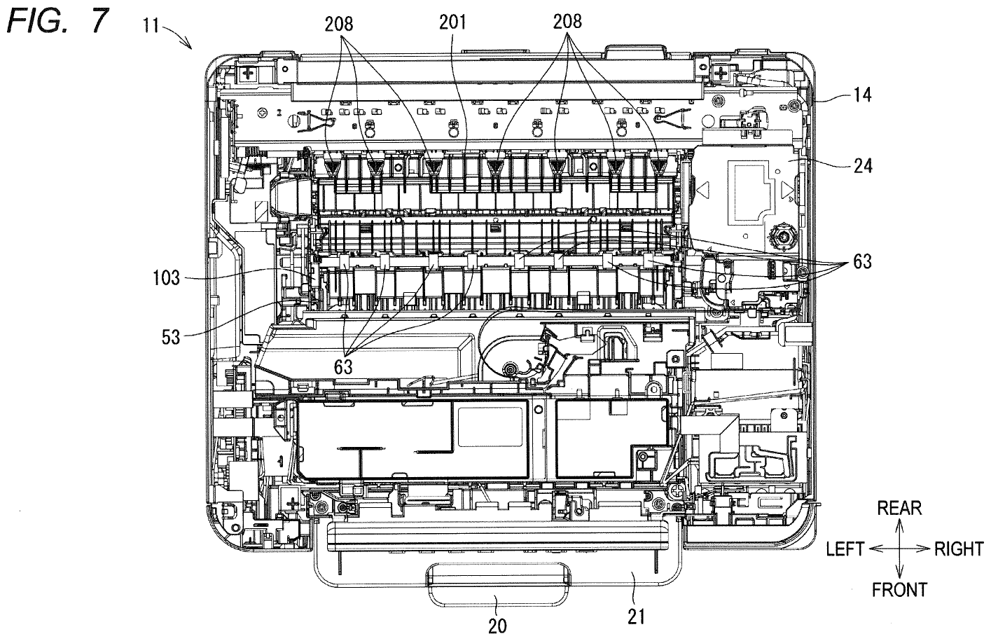

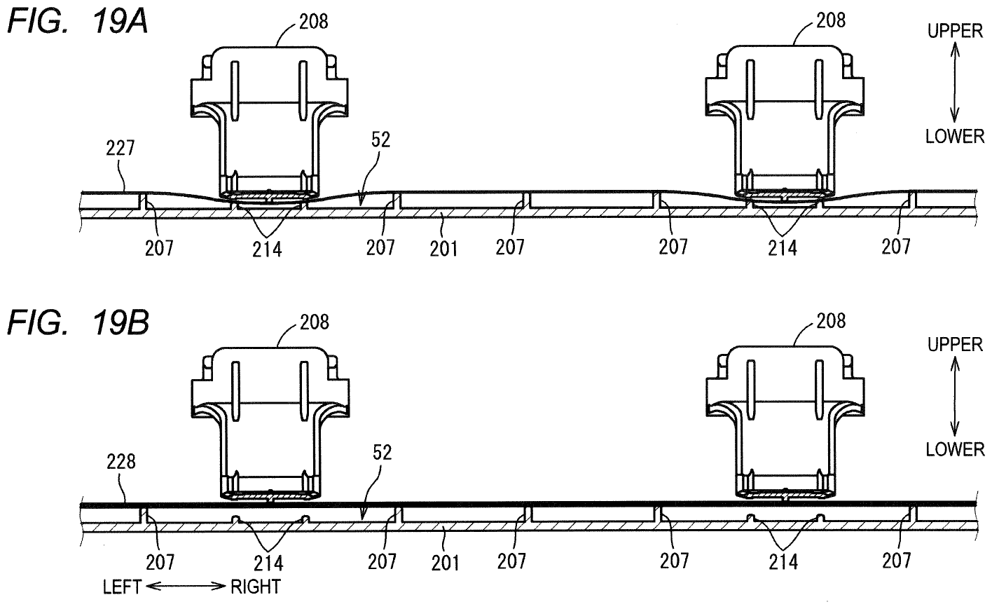

As shown in FIG. 3, a plurality of first platen ribs 207 and a plurality of second platen ribs 214, which extend in the conveyance direction, are arranged to protrude from the first guide surface 52. The height of the first platen rib 207 from the first guide surface 52 is greater than the height of the second platen rib 214 from the first guide surface 52. The length of the first platen rib 207 in the conveyance direction is longer than the length of the second platen rib 214 in the conveyance direction. In a top view, three first platen ribs 207 are disposed between two corrugated members 208, and two first platen ribs 207 are disposed on each of the outer sides of the corrugated members 208 in the left-right direction. Two second platen ribs 214 are disposed immediately below each corrugated member 208. As shown in FIGS. 5 and 7, the corrugated members 208 press the sheet 12 against the second platen ribs 214 between two first platen ribs 207 adjacent to each other in the main scanning direction. When the sheet 12 is the plain paper 227, the corrugating member 208 forms a corrugated shape (wave shape) that undulates along the main scanning direction as shown in FIG. 19A. This prevents the plain paper 227 from being lifted from the first guide surface 52 due to curling, for example.

The pair of platen rear protrusions 204 protrude rearward from both left and right ends of a rear long side of the substantially rectangular shape in a top view. The upper surface of the platen rear protrusion 204 is a platen concave surface 205. The platen concave surface 205 is slidably fitted to the inner portion of the conveyance roller bearing 210. Accordingly, the platen 201 is pivotable about the first pivot shaft 31 of the conveyance roller 60, and the first guide 54 is movable between the third position and the fourth position. When the first guide 54 is located at the third position and the first conveyance-path guide 42 is positioned, the conveyance roller bearing 210 as a first restricting portion contacts the platen concave surface 205 of the first conveyance-path guide 42 and restricts the movement of the first conveyance-path guide 42 in a direction toward the print head 38. Thus, the platen concave surface 205 corresponds to a first contact portion that contacts the first restricting portion.

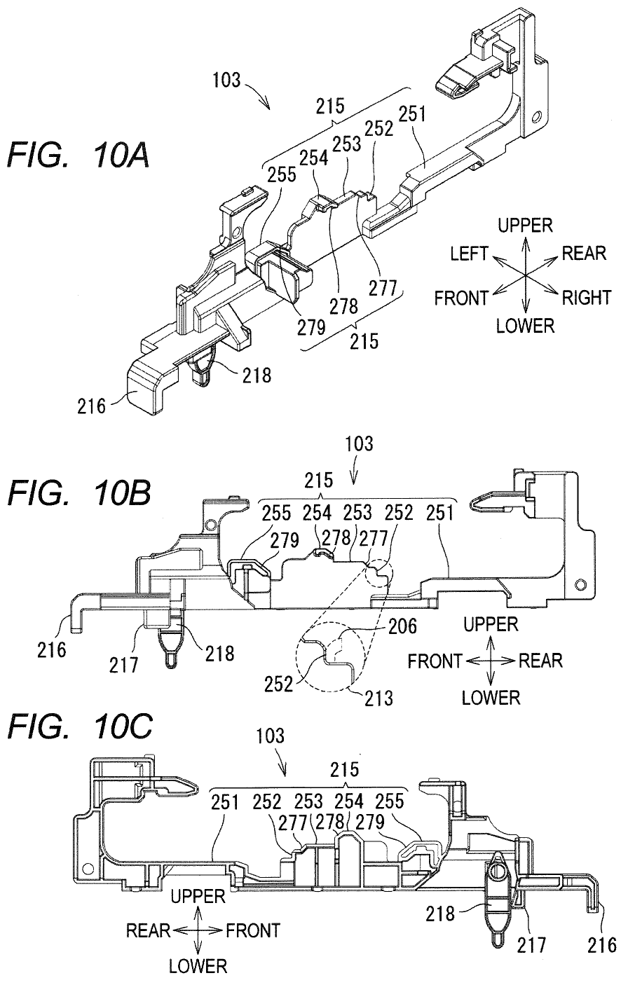

The platen side protrusions 206 protrude laterally from the sides of the platen 201 toward the slider 103. When the first guide 54 is located at the third position, the platen side protrusion 206 is located at a position higher than an upper end (a cam surface described later) of the slider 103. When the first guide 54 is located at the fourth position, as shown in a broken-line circle 213 in FIG. 10B, the platen side protrusion 206 contacts a vertical surface extending in the upper-lower direction of the cam surface of the slider 103 from the rear side. With this configuration, the platen 201 restricts the slider 103 from moving rearward in the front-rear direction due to the attachment of the feed tray 20.

The platen movable member 202 is attached to the platen 201 so as to be displaceable relative to the platen 201. When the first guide 54 is located at the third position and the first conveyance-path guide 42 is positioned, the platen movable member 202 contacts the slider 103. The slider 103 corresponds to a second restricting portion that contacts the platen movable member 202 of the first conveyance-path guide 42 and restricts the movement of the first conveyance-path guide 42 in a direction away from the print head 38. The lower end of the platen movable member 202 serves as a second contact portion 263 that contacts the second restricting portion.

The platen elastic member 203 urges the upstream end portion of the platen 201 in the conveyance direction and the platen movable member 202 in directions away from each other. In the present embodiment, a coil spring is used as the platen elastic member 203, and one end in the coil axis direction contacts the lower surface of the platen 201, and the other end contacts the upper surface of the platen movable member 202. An elastic member other than a coil spring may be used as the platen elastic member 203. When the platen 201 is pressed against the sheet 12, the platen elastic member 203 is elastically compressed in accordance with the pressing force, and the platen 201 is displaced in the upper-lower direction.

For example, when the sheet 12 is the thick paper 228, the thick paper 228 has high stiffness and is not easily bent, and thus, as shown in FIG. 19B, when the thick paper 228 is pressed by the corrugated members 208, the thick paper 228 contacts the first platen ribs 207, but does not contact the second platen ribs 214, and maintains a flat shape. The platen elastic member 203 is elastically compressed and the platen 201 is displaced downward, whereby the head gap is maintained constant. More specifically, a front end of the platen 201 (a fifth contact portion 266 in contact with a discharge roller bearing lower surface 258 described later) is fixed in position, and the platen 201 is displaceable (pivotable) about the front end. As shown in FIG. 4, clearance 209 is provided in the vertical direction between the first conveyance-path guide 42 and the pressure receiving member 55 in a state where the first conveyance-path guide 42 and the pressure receiving member 55 are positioned. Thus, even when the platen 201 is displaced in the upper-lower direction, the platen 201 does not interfere with the pressure receiving member 55. The pressure receiving member 55 does not hinder the displacement of the platen 201.

At the time of positioning, the bottom of the platen concave surface 205 of the platen 201 contacts a conveyance roller bearing lower surface 256. The platen concave surface 205 serves as a first contact portion 262. The lower end of the platen movable member 202 serves as the second contact portion 263 and contacts a first cam surface 251 of the slider 103. A lower portion of the front end portion of the platen 201 serves as a fourth contact portion 265 and contacts a fifth cam surface 255 of the slider 103. An upper portion of the front end portion of the platen 201 serves as the fifth contact portion 266 and contacts the discharge roller bearing lower surface 258.

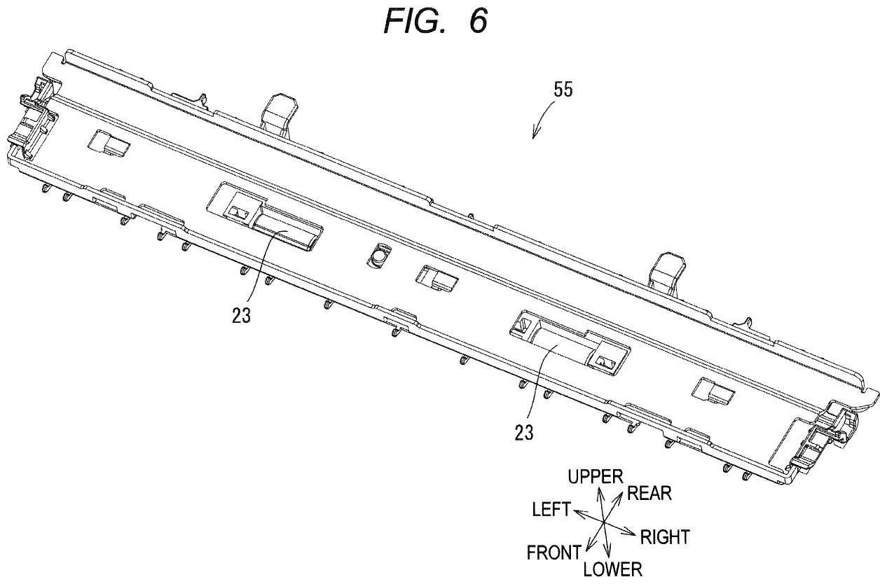

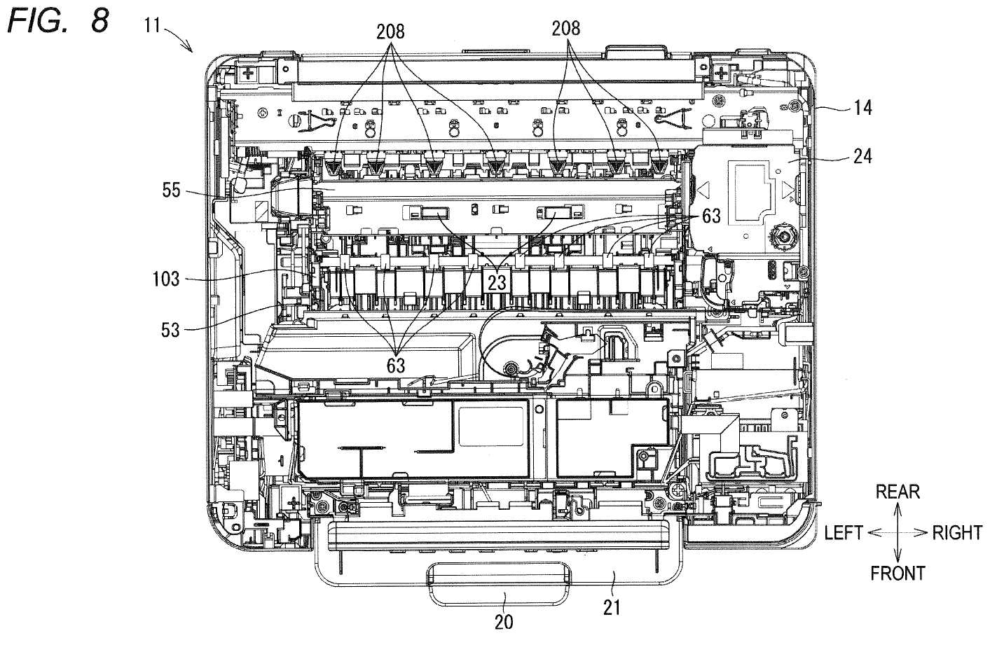

As shown in FIG. 6, the pressure receiving member 55 includes the second guide surface 50 and the pinch roller 23. The second guide surface 50 defines the second conveyance path 71 located below the first conveyance path 65. Thus, when the first conveyance-path guide 42 is detached, the second guide surface 50 is exposed as shown in FIG. 8. The first conveyance-path guide 42 has a recess (not shown), and the pressure receiving member 55 has a protrusion (not shown). The protrusion of the pressure receiving member 55 is loosely fitted into the recess of the first conveyance-path guide 42. With this loose fitting, the first guide surface 52 of the first conveyance-path guide 42 is displaceable downward relative to the pressure receiving member 55. Since the amount of the displacement is restricted within a certain range by the loose fitting, the pressure receiving member 55 pivots integrally with the first conveyance-path guide 42 as the first guide 54.

The pinch roller 23 is in pressure contact with the re-conveyance roller 22 of the second guide 74. Thus, the pressure receiving member 55 receives a pressing force from the second guide 74, which is another member. The cam surface of the slider 103 contacts the lower surface of the pressure receiving member 55, and the upper surface of the pressure receiving member 55 contacts the side frame 53 from below, so that the pressure receiving member 55 is positioned. The pressing force applied to the pressure receiving member 55 by the second guide 74 is received by the side frame 53. The clearance 209 is provided between the pressure receiving member 55 and the first conveyance-path guide 42. Thus, the pressing force to the pressure receiving member 55 is not transmitted to the first conveyance-path guide 42, and thus the positioning of the first conveyance-path guide 42 is maintained with high accuracy.

When the pressure receiving member 55 is positioned, a rear lower surface of the pressure receiving member 55 serves as a seventh contact portion 268 and contacts a third cam surface 253 of the slider 103. A front lower surface of the pressure receiving member 55 serves as an eighth contact portion 269 and contacts a fourth cam surface 254 of the slider 103. A rear upper surface of the pressure receiving member 55 serves as a ninth contact portion 270 and contacts a first frame positioning portion 260 of the side frame 53. The front upper surface of the pressure receiving member 55 serves as a tenth contact portion 271 and contacts a second frame positioning portion 261 of the side frame 53.

As shown in FIGS. 9A and 9B, the side frame 53 is a sheet metal member elongated in the front-rear direction. The side frame 53 includes a frame vertical portion 220 and a frame horizontal portion 221. The frame vertical portions 220 are disposed along the left and right side surfaces of the housing 14. FIGS. 9A and 9B illustrate the left side frame 53. At the right end of the inside of the housing 14, the right side frame 53 is disposed which is symmetrical to the left side frame 53 shown in FIGS. 9A and 9B with respect to a plane perpendicular to the left-right direction. The frame horizontal portion 221 extends inward in the left-right direction from the lower end of the frame vertical portion 220. The side frames 53 are disposed on the left and right outer sides of the slider 103 in a top view.

The frame vertical portion 220 includes the first cutout 222, the second cutout 223, the third cutout 224, a first frame positioning portion 260, and a second frame positioning portion 261. The frame vertical portion 220 pivotally supports a lever member 218 in a pivotable manner. The conveyance roller bearing 210 is fitted into the first cutout 222. The discharge roller bearing 211 is fitted into the second cutout 223. The reverse roller bearing 212 is fitted into the third cutout 224. The first frame positioning portion 260 and the second frame positioning portion 261 are portions formed by bending a part of the frame vertical portion 220 inward in the left-right direction by 90 degrees. The first frame positioning portion 260 is disposed at a position where the first frame positioning portion 260 contacts the ninth contact portion 270 of the pressure receiving member 55 at the time of positioning. The second frame positioning portion 261 is disposed at a position where the second frame positioning portion 261 contacts the tenth contact portion 271 of the pressure receiving member 55.

The frame horizontal portion 221 has a fourth cutout 225. The fourth cutout 225 is a through hole that receives the pivoting of the lever member 218. The lever member 218 hangs down from a pivot shaft position in the fourth cutout 225. The slider 103 is placed on the frame horizontal portion 221. The frame horizontal portion 221 is fixed to the housing 14.

The slider 103 is a member that is long in the front-rear direction and narrow in the left-right direction. The slider 103 is a rectilinear cam that moves linearly in the front-rear direction inside the housing 14 in conjunction with the attachment and detachment of the feed tray 20. The slider 103 includes a cam portion 215, a feed tray pressing portion 216, and a lever contact portion 217. The sliders 103 are disposed on both left and right sides of the platen 201 in a top view. FIGS. 10A, 10B and 10C show the left slider 103. The slider 103 is movable linearly between a first position shown in FIG. 14 and a second position shown in FIG. 15. The lever member 218 is pivotally supported by the side frame 53, but is not connected to the slider 103. The lever member 218 contacts the lever contact portion 217 in accordance with the movement of the slider 103. The lever member 218 shown in FIGS. 10A, 10B and 10C shows the positional relationship with the slider 103.

A part of the upper end of the slider 103 is the cam portion 215, and the height of the slider 103 changes along the front-rear direction. The cam portion 215 has the first cam surface 251, a second cam surface 252, the third cam surface 253, the fourth cam surface 254, and the fifth cam surface 255. The first cam surface 251, the third cam surface 253, the fourth cam surface 254, and the fifth cam surface 255 are horizontal surfaces. When the slider 103 is located at the first position, the first cam surface 251 contacts the second contact portion 263 of the platen movable member 202. The third cam surface 253 contacts the seventh contact portion 268 of the pressure receiving member 55. The fourth cam surface 254 contacts the eighth contact portion 269 of the pressure receiving member 55. The fifth cam surface 255 contacts the fourth contact portion 265 of the platen 201. In this manner, the slider 103 contacts the first conveyance-path guide 42 and the pressure receiving member 55 when the slider 103 is located at the first position, and performs positioning. As a result, the first guide 54 moves to the third position.

The second cam surface 252 is a vertical surface. When the slider 103 is located at the second position, the second cam surface 252 contacts the platen side protrusion 206. When the slider 103 is located at the second position, the first cam surface 251, the third cam surface 253, the fourth cam surface 254, and the fifth cam surface 255 are released from the pressure contact. In this manner, the slider 103 is separated from the first conveyance-path guide 42 and the pressure receiving member 55 when the slider 103 is located at the second position, and the positioning is released. This allows the first guide 54 to move downward toward the fourth position.

The feed tray pressing portion 216 is located at a front end of the slider 103. The feed tray pressing portion 216 is disposed at a height at which a slider pressing portion 235 of the feed tray 20 contacts the feed tray pressing portion 216 when the feed tray 20 is attached. When the slider pressing portion 235 of the feed tray 20 presses the feed tray pressing portion 216 of the slider 103, the slider 103 moves linearly from the second position to the first position. As described above, the slider 103 is configured to move linearly from the second position to the first position in conjunction with the attachment of the feed tray 20.

The lever contact portion 217 protrudes downward from the lower surface of the body of the slider 103 at a position rearward of the feed tray pressing portion 216 and forward of the lever member 218. The lower surface of the slider 103 is a surface that slides on the upper surface of the frame horizontal portion 221 of the side frame 53 when the slider 103 moves linearly in the front-rear direction. When a lever pressing portion 236 of the feed tray 20 contacts the lever member 218 and pivots the lever member 218 at the time of detachment of the feed tray 20, the lever member 218 contacts the lever contact portion 217, presses the slider 103 forward, and moves the slider 103 linearly to the second position. In this way, the slider 103 moves linearly from the first position to the second position in conjunction with the detachment of the feed tray 20.

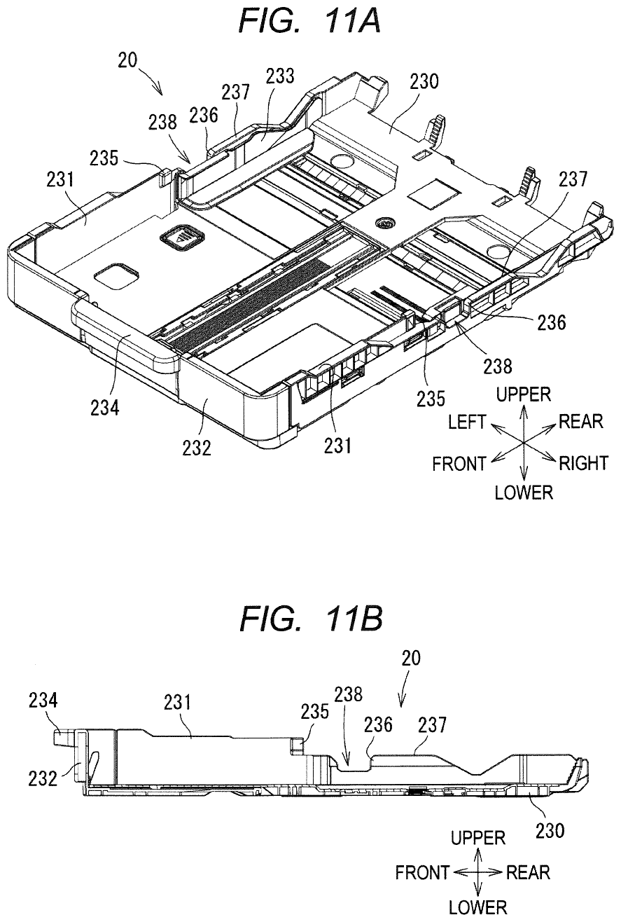

As shown in FIGS. 11A and 11B, the feed tray 20 includes a tray bottom plate 230, tray side plates 231, and a tray front plate 232. A sheet width guide 233 is attached to the tray bottom plate 230 so as to be slidable in the left-right direction. The sheet width guide 233 is a guide member for arranging the sheet 12 at the center of the feed tray 20 in the left-right direction. Tray side plates 231 extend vertically from both side ends of the tray bottom plate 230 in the left-right direction, and the tray front plate 232 extends vertically from the front end of the tray bottom plate 230. The tray front plate 232 has a handle 234 for detaching the feed tray 20. As shown in FIG. 4, the feed tray 20 is attached below the positioned first guide 54.

The tray side plate 231 includes the slider pressing portion 235 and the lever pressing portion 236. The slider pressing portion 235 is a substantially vertical surface, and the tray side plate 231 is high on the front side of the slider pressing portion 235 and the tray side plate 231 is low on the rear side of the slider pressing portion 235. The slider pressing portion 235 presses the feed tray pressing portion 216 of the slider 103 when the feed tray 20 is attached. The feed tray pressing portion 216 is disposed such that the slider 103 is located at the first position when the attachment of the feed tray 20 is completed. A portion of the feed tray 20 rearward of the slider pressing portion 235 is lower than the lower end of the feed tray pressing portion 216 of the slider 103 so as not to contact the feed tray pressing portion 216 when the feed tray 20 is attached.

The lever pressing portion 236 is a substantially vertical surface, and the rear side of the lever pressing portion 236 is a tray side plate high portion 237 where the tray side plate 231 is high, and the front side of the lever pressing portion 236 is a tray side plate low portion 238 where the tray side plate 231 is low. When the feed tray 20 is attached, the lever member 218 climbs over the tray side plate high portion 237, reaches the tray side plate low portion 238, and hangs down. When the feed tray 20 is detached, the lever pressing portion 236 presses the lever member 218 from the rear to the front to pivot the lever member 218 to the front. By this pivoting, the lever member 218 contacts the lever contact portion 217 of the slider 103 and presses the slider 103 toward the front. This pressing causes the slider 103 to move linearly from the first position to the second position. When the lower end of the lever member 218 is raised to the height of the tray side plate high portion 237, the lever member 218 takes a pivoted posture in which the lever member 218 is pivoted to the front. When the lever member 218 climbs over the tray side plate 231 in the pivoted posture, the feed tray 20 is detached, and the lever member 218 returns to the hanging posture. In this way, the lever member 218 is pressed by the feed tray 20. In addition, the lever member 218 is pivotable by a manual operation in a state where the feed tray 20 is detached.

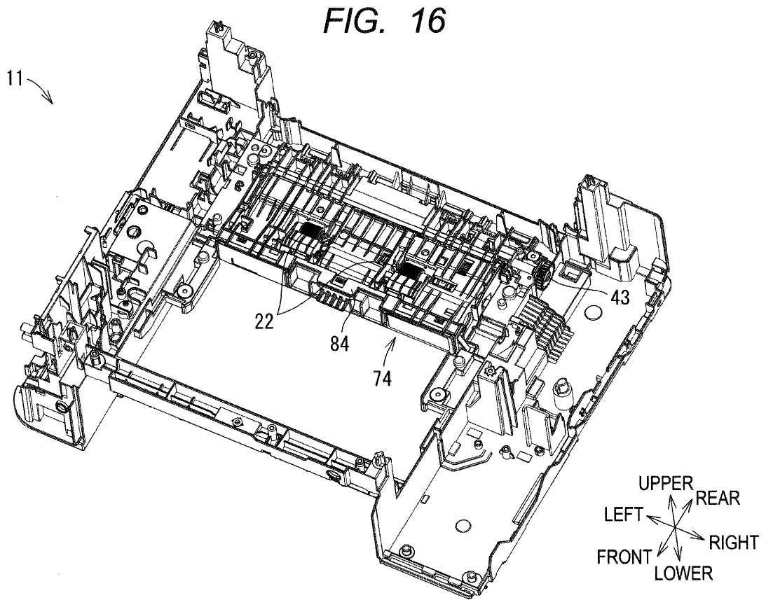

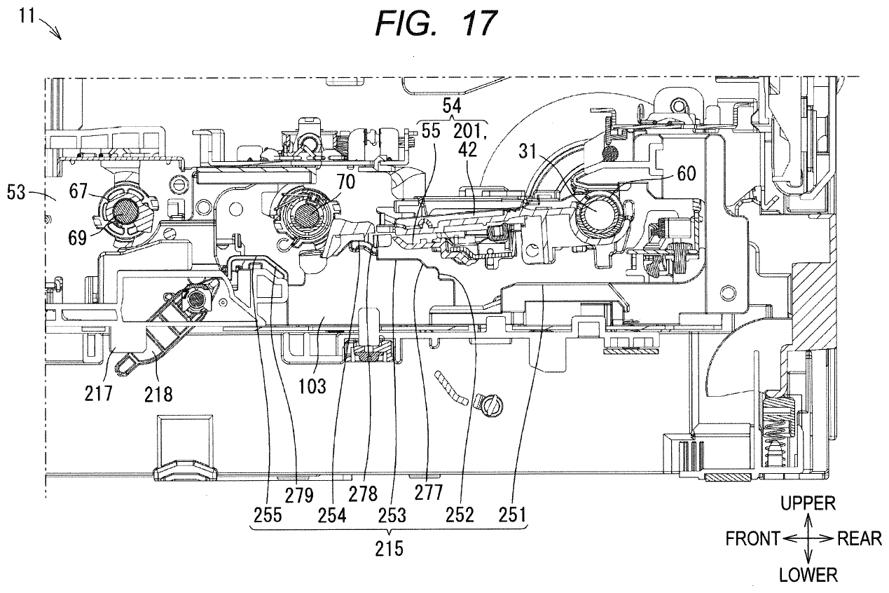

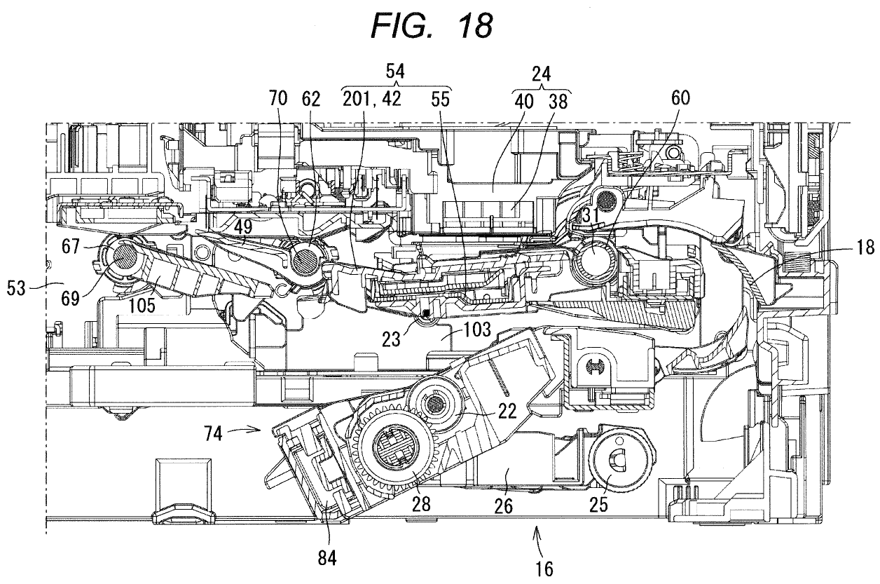

As shown in FIGS. 2 and 16, the second guide 74 includes the third guide surface 76, the re-conveyance roller 22, and an engagement portion 84. The third guide surface 76 faces the second guide surface 50 of the pressure receiving member 55 and defines the second conveyance path 71. The re-conveyance roller 22 is a drive roller that is pressed against the pinch roller 23 of the pressure receiving member 55 to convey the sheet 12 along the second conveyance path 71. The second guide 74 is pivotally supported by a second pivot shaft 43. The second pivot shaft 43 is located below the first pivot shaft 31 of the first guide 54. The second pivot shaft 43 is parallel to the first pivot shaft 31. The second guide 74 is configured to pivot about the second pivot shaft 43 to move between a fifth position where the sheet 12 conveyed along the second conveyance path 71 is guided by the third guide surface 76 and a sixth position where the first conveyance path 65 or the second conveyance path 71 is opened. The fifth position is the position shown in FIG. 4. The sixth position is the position shown in FIGS. 15 and 18. The second guide 74 is located below the first guide 54 and supports the first guide 54, which is released from the positioning, above the feed tray 20.

The engagement portion 84 is disposed at a front end portion of the second guide 74. When the second guide 74 is located at the fifth position, the engagement portion 84 protrudes in both the left and right directions from the front end portion of the second guide 74 and engages with the housing 14. The engagement portion 84 is configured to reciprocate in the left-right direction between a release position where engagement with the housing 14 is released and an engagement position where the engagement portion 84 is engaged with the housing 14. The second guide 74 is held at the fifth position by the engagement between the engagement portion 84 and the housing 14. The engagement portion 84 is urged toward the engagement position by an urging member (not shown). The engagement between the engagement portion 84 and the housing 14 is maintained by an urging force of the urging member. The engagement portion 84 is movable from the engagement position to the release position against the urging force of the urging member by a manual operation to release the engagement with the housing 14.

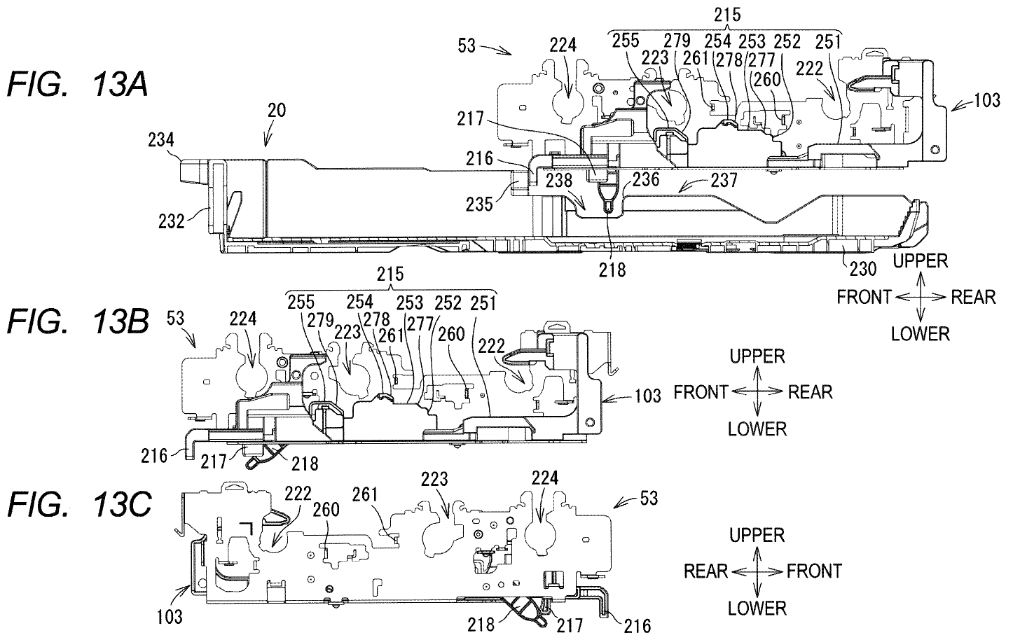

When the second guide 74 is located at the sixth position, the front end portion of the second guide 74 is pivoted to a position within the movement range of the feed tray 20. Thus, as shown in FIG. 15, when the second guide 74 is located at the sixth position, even if the user attempts to attach the feed tray 20, the rear end of the feed tray 20 contacts the distal end of the second guide 74, and thus, the user cannot move the feed tray 20 rearward from the contact position. The second guide 74 restricts the attachment of the feed tray 20 at the sixth position before the feed tray 20 and the slider 103 contact each other as shown in FIG. 13A. The second guide 74 is movable from the sixth position to the fifth position by a manual operation, and the engagement portion 84 and the housing 14 are engaged with each other when the second guide 74 is located at the fifth position.

The second guide 74 pivotally supports the feed arm 26. The feed arm 26 includes a drive transmission mechanism 27. The drive transmission mechanism 27 transmits a rotational driving force of a conveyance motor (not shown) that rotationally drives the conveyance roller 60 to the feed roller 25.

In the printer unit 11, a jam (that is, a paper jam) may occur when the sheet 12 is conveyed in the apparatus. A jam is detected as follows. For example, conveyance sensors (sheet sensors) are arranged, and in a case where an elapsed time from when the conveyance sensor on the upstream side in the conveyance direction detects the sheet 12 to when the conveyance sensor on the downstream side detects the sheet 12 is within a particular time, it is determined that a jam has not occurred, and in a case where the elapsed time exceeds the particular time, it is determined that a jam has occurred between these conveyance sensors. The jam may be detected by other configurations and methods. When the printer unit 11 detects a jam, the printer unit 11 notifies the occurrence of the jam by sounding an alarm, turning on a lamp, or displaying a message on a liquid crystal display (LCD).

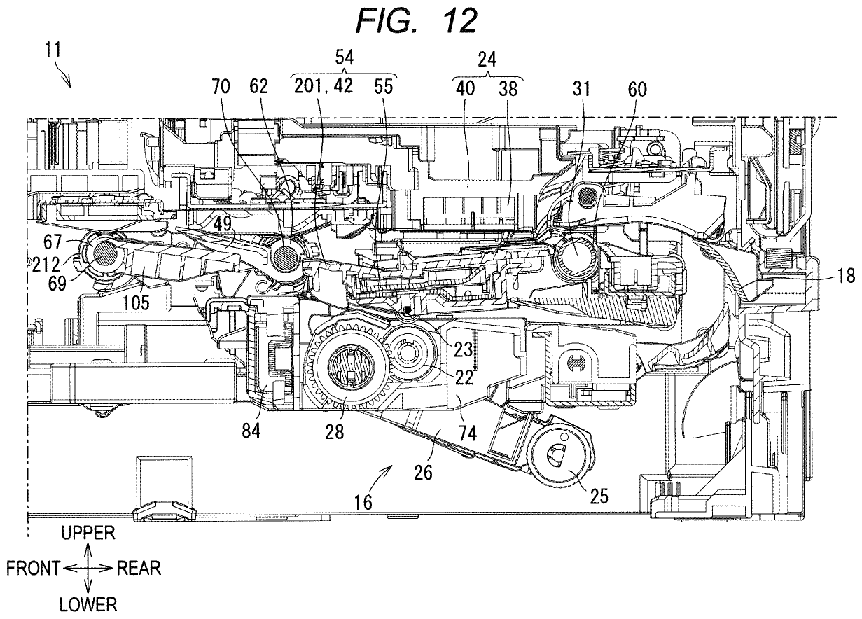

A jam removal processing will be described. When a jam occurs, a jam removal processing is performed at the printer unit 11 as follows. When a jam occurs, as shown in FIG. 4, the slider 103 is located at the first position, the first guide 54 is located at the third position, and the second guide 74 is located at the fifth position.
(1) The feed tray 20 is detached. When the slider 103 is moved linearly from the first position to the second position in conjunction with the detachment of the feed tray 20, the positioning of the first guide 54 is released. The second guide 74 is maintained at the fifth position by the engagement between the engagement portion 84 and the housing 14. Thus, as shown in FIG. 12, the first guide 54 is supported by the second guide 74 while the pinch roller 23 and the re-conveyance roller 22 are in contact with each other.
(2) The second guide 74 is moved from the fifth position to the sixth position. When the operator of jam removal processing inserts his or her hand through the opening 13 in the front surface of the housing 14 and manually operates the engagement portion 84 of the second guide 74 to disengage the engagement portion 84 from the housing 14, the second guide 74 pivots about the second pivot shaft 43 by its own weight and moves from the fifth position to the sixth position. When a jam occurs in the first conveyance path 65, as shown in FIG. 15, the first guide 54 pivots about the first pivot shaft 31 by its own weight and moves from the third position to the fourth position, and the first conveyance path 65 is opened. This allows the operator to access and remove the sheet 12 jammed in the first conveyance path 65.

When a jam occurs in the second conveyance path 71, as shown in FIG. 18, the first guide 54 may be supported by the sheet 12 (not shown) jammed in the second conveyance path 71 and may not be able to move to the fourth position. At this time, too, the second guide 74 is moved to the sixth position, and the second conveyance path 71 is opened. This allows the operator to access and remove the sheet 12 jammed in the first conveyance path 65. As shown in FIG. 15, when a jam occurs in the second conveyance path 71 and the first guide 54 is not supported by the sheet 12 jammed in the second conveyance path 71 and is moved to the fourth position, the jam is removed in a similar manner to when a jam occurs in the first conveyance path 65.

When the second guide 74 is located at the sixth position, as described above, the attachment of the feed tray 20 is restricted, and the feed tray 20 does not contact the slider 103, and thus the slider 103 is maintained at the second position. When the first guide 54 is moved to the fourth position, the platen side protrusion 206 contacts the second cam surface 252 of the slider 103, and thus the slider 103 is maintained at the second position. This prevents the platen 201 from being damaged or deformed due to the collision of the slider 103 with the first guide 54 located at the fourth position, or the slider 103 from being damaged or deformed due to the collision of the feed tray 20 with the slider 103 located at the second position, which may be caused by the erroneous attachment of the feed tray 20 by the operator.
(3) The second guide 74 is returned from the sixth position to the fifth position. After the jam removal, the operator lifts the second guide 74 from the sixth position to the fifth position to engage the engagement portion 84 with the housing 14. As a result, the second guide 74 is held at the fifth position. As shown in FIG. 12, the first guide 54 is pushed up together with the second guide 74 and supported by the second guide 74. Thus, the re-conveyance roller 22 of the second guide 74 presses the pinch roller 23 of the first guide 54, thereby reducing the displacement of the first guide 54. This is referred to as temporary positioning of the first guide 54. In the temporary positioning, the restriction of the movement of the feed tray 20 by the second guide 74 and the restriction of the linear movement of the slider 103 by the first guide 54 are released. However, since the first guide 54 is lifted to a position close to the third position, even when the feed tray 20 is attached, the slider 103 does not collide with the first guide 54.
(4) The feed tray 20 is attached. When the feed tray 20 is inserted into the opening 13 of the housing 14 and the feed tray 20 is attached to the printer unit 11, the slider 103 moves linearly from the second position to the first position in conjunction with the attachment of the feed tray 20, and the first guide 54 that has been temporarily positioned is positioned as shown in FIG. 4.

The positioning of the first guide 54 will be described. The first conveyance-path guide 42 and the pressure receiving member 55 constituting the first guide 54 are positioned as follows. As shown in FIG. 14, as the slider 103 moves linearly from the second position to the first position, an eighth cam surface 279 of the slider 103 is first pressed against a thirteenth contact portion 274 of the platen 201. The eighth cam surface 279 is an inclined surface, and the thirteenth contact portion 274 is lifted up as the slider 103 moves. Next, a seventh cam surface 278 of the slider 103 is pressed against the twelfth contact portion 273 of the pressure receiving member 55. The seventh cam surface 278 is also an inclined surface, and the twelfth contact portion 273 is lifted. Further, a sixth cam surface 277 of the slider 103 is pressed against the eleventh contact portion 272 of the pressure receiving member 55. The sixth cam surface 277 is also an inclined surface, and the eleventh contact portion 272 is lifted. As a result, the first conveyance-path guide 42 and the pressure receiving member 55 are positioned as follows.

The positioning of the first conveyance-path guide 42 will be described. As shown in FIG. 14, when the first cam surface 251 of the slider 103 is pressed against the second contact portion 263 of the platen movable member 202 at the time of positioning, the first contact portion 262 of the platen 201 is pressed against the conveyance roller bearing lower surface 256, and thus the first conveyance-path guide 42 is sandwiched between the slider 103 and the conveyance roller bearing 210. When the fifth cam surface 255 of the slider 103 is pressed against the fourth contact portion 265 of the platen 201, the fifth contact portion 266 of the platen 201 is pressed against the discharge roller bearing lower surface 258, and thus the first conveyance-path guide 42 is sandwiched between the slider 103 and the discharge roller bearing 211. These members position the first conveyance-path guide 42 and define the head gap.

The positioning of the pressure receiving member 55 will be described. As shown in FIG. 14, at the time of positioning of the pressure receiving member 55, when the third cam surface 253 of the slider 103 is pressed against the seventh contact portion 268 of the pressure receiving member 55, the ninth contact portion 270 of the pressure receiving member 55 is pressed against the first frame positioning portion 260 of the side frame 53, and thus the pressure receiving member 55 is sandwiched between the slider 103 and the side frame 53. When the fourth cam surface 254 of the slider 103 is pressed against the eighth contact portion 269 of the pressure receiving member 55, the tenth contact portion 271 of the pressure receiving member 55 is pressed against the second frame positioning portion 261 of the side frame 53, and thus the pressure receiving member 55 is sandwiched between the slider 103 and the side frame 53. By these, the pressure receiving member 55 is positioned.
(1) Advantageous effects of the embodiment will be described. The first conveyance-path guide 42 and the pressure receiving member 55 constituting the first guide 54, and the second guide 74 are members defining the first conveyance path 65 and the second conveyance path 71, and these members are to be positioned highly accurately for printing. The first conveyance-path guide 42 is to be positioned as a member for supporting the sheet 12 during printing. The pressure receiving member 55 is to be positioned as a member defining the upper side of the second conveyance path 71. The second guide 74 is to be positioned as a member defining the lower side of the second conveyance path 71. Thus, these members have different positioning requirements. However, if each member is individually positioned for each positioning requirement, each time the jam removal processing is performed, seven steps of operations are performed, that is, (a) the feed tray 20 is detached, (b) the positioning of the second guide 74 is released, (c) the positioning of the pressure receiving member 55 is released, (d) the second guide 74 is retracted to open the second conveyance path 71, (e) the pressure receiving member 55 is retracted, and (f) the first conveyance-path guide 42 is retracted to open the first conveyance path 65, which is troublesome and has low usability.

According to the present embodiment, even when a jam occurs in either the first conveyance path 65 or the second conveyance path 71, the conveyance path in which the sheet 12 is jammed is opened and the sheet 12 is accessed by a two step operation of detaching the feed tray 20 from the printer unit 11 and releasing the engagement between the engagement portion 84 of the second guide 74 and the housing 14. Thus, the operation is simple, and high usability is achieved.
(2) After the jam removal processing is completed, the engagement portion 84 and the housing 14 are engaged with each other by the operation of lifting the second guide 74, and the first guide 54 is temporarily positioned. Since the temporarily positioned first guide 54 is located at a position close to the third position where the first guide 54 is positioned, the moving distance of the first guide 54 required for positioning the first guide 54 is small. Thus, the first guide 54 is positioned by a small action using the compact slider 103, and thus an increase in the size of the apparatus is avoided. Further, since the long slider 103 is moved linearly in the longitudinal direction, the space used for the movement of the slider 103 is small, and thus the increase in size of the apparatus is avoided.
(3) The first conveyance-path guide 42 and the pressure receiving member 55 are not integrated with each other, but are combined with play, and the positioning of each is separately performed. In particular, since the pressing force of the re-conveyance roller 22 applied to the pinch roller 23 of the pressure receiving member 55 is received by the side frame 53, the load due to the pressing force is not applied to the first conveyance-path guide 42, particularly, the upstream side of the platen 201 (that is, the rear side in the front-rear direction). Similarly, pressure from the feed arm 26 is not applied to the platen 201. Thus, the first conveyance-path guide 42 is positioned with high accuracy. Since deformation of the first conveyance-path guide 42 is prevented, the positioning accuracy of the first conveyance-path guide 42 is maintained high.
(4) The clearance 209 is provided between the first conveyance-path guide 42 and the pressure receiving member 55, and the first conveyance-path guide 42 and the pressure receiving member 55 do not interfere with each other when the upstream side of the platen 201 is displaced up and down during printing. Thus, the head gap is maintained constant. Thus, the possibility of occurrence of a jam is reduced to a low level, and an image of excellent quality is printed.
(5) The slider 103 is used for both the positioning of the first conveyance-path guide 42 and the positioning of the pressure receiving member 55. This reduces the number of components used for the positioning, and prevents an increase in the size and cost of the MFP 10 and an increase in the amount of CO2 emission.
(6) The first conveyance-path guide 42 and the pressure receiving member 55 are positioned by moving the slider 103 linearly once. This prevents an increase in the size of the MFP 10 and reduces a work space for jam removal processing. Further, since the number of work processes for the jam removal is reduced, usability is improved.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.
(1) In the above-described embodiment, the slider 103 is the rectilinear cam, but the present disclosure is not limited to the rectilinear cam, and a rotary cam that rotates in accordance with the attachment and detachment of the feed tray 20 may be used instead of the rectilinear cam, or a member other than the cam may be used. In this case, too, the space is saved compared to the example in which the platen support member is rotated about the vertical axis.
(2) In the above-described embodiment, the first guide 54 is configured such that the protrusion of the pressure receiving member 55 is loosely fitted into the recess of the first conveyance-path guide 42, but the first conveyance-path guide 42 and the pressure receiving member 55 may be connected to each other by a method other than loose fitting as long as the first guide surface 52 is displaceable downward relative to the pressure receiving member 55. For example, the first conveyance-path guide 42 and the pressure receiving member 55 may be connected to each other via an elastic member. With this configuration, too, the first conveyance path 65 and the second conveyance path 71 is opened by a simple operation, and the first conveyance-path guide 42 and the pressure receiving member 55 are positioned.
(3) In the above-described embodiment, the printer unit 11 has the second conveyance path 71. However, even in the printer unit 11 not having the second conveyance path 71, when the pressure by the feed arm 26 is applied to the platen 201, there is a possibility that the quality of the image is deteriorated or the platen 201 has creep deformation. In contrast, as in the present disclosure, by adopting a configuration that the first conveyance-path guide 42 and the pressure receiving member 55 are not integrated with each other, but are combined with each other with a play, and are separately positioned, the problem due to the pressure from the feed arm 26 may be prevented.
(4) The MFP 10 according to the above-described embodiment may have a scanner function and a facsimile function in addition to a printing function. Further, the present disclosure may be applied to a printing apparatus having a printing function, other than the MFP 10, and effects similar to those when applied to the MFP 10 are obtained.

What is claimed is:

1. A printing apparatus comprising:
a housing;
a first conveyance-path guide disposed in the housing, the first conveyance-path guide including a first guide surface defining a first conveyance path;
a second conveyance-path guide disposed in the housing, the second conveyance-path guide including a second guide surface defining a second conveyance path; and
a slider disposed in the housing, the slider being movable between:
a first position at which the slider contacts and positions each of the first conveyance-path guide and the second conveyance-path guide; and
a second position at which the slider separates from the first conveyance-path guide and the second conveyance-path guide, and releases positioning of the first conveyance-path guide and the second conveyance-path guide.

2. The printing apparatus according to claim 1, wherein the first conveyance-path guide and the second conveyance-path guide are assembled into a first guide;
wherein the first guide is movable between:
a third position at which the slider is located at the first position and the first guide guides a sheet conveyed along the first conveyance path by the first guide surface; and
a fourth position at which the first guide is moved downward from the third position.

3. The printing apparatus according to claim 1, further comprising a tray,
wherein the slider is configured to move from the first position to the second position in conjunction with detachment of the tray and to release the positioning.

4. The printing apparatus according to claim 3, further comprising a second guide,
wherein the first conveyance-path guide and the second conveyance-path guide become movable downward due to release of the positioning;
wherein the tray is configured to be attached to a position below the first conveyance-path guide and the second conveyance-path guide that are positioned; and
wherein the second guide is configured to support, above the tray, the first conveyance-path guide and the second conveyance-path guide that are released from the positioning.

5. The printing apparatus according to claim 4, wherein the first conveyance-path guide and the second conveyance-path guide are assembled into a first guide;
wherein the first guide is movable between:
a third position at which the slider is located at the first position and the first guide guides a sheet conveyed along the first conveyance path by the first guide surface; and
a fourth position at which the first guide is moved downward from the third position;
wherein the second guide includes a third guide surface defining the second conveyance path;
wherein the second guide is movable between:
a fifth position at which the second guide guides a sheet conveyed along the second conveyance path by the third guide surface; and
a sixth position at which the second guide opens the second conveyance path; and
wherein the first guide is configured to move to the fourth position due to movement of the second guide to the sixth position.

6. The printing apparatus according to claim 1, further comprising a tray,
wherein the slider is configured to move from the second position to the first position in conjunction with attachment of the tray, and to position the first conveyance-path guide and the second conveyance-path guide.

7. The printing apparatus according to claim 6, further comprising a second guide,
wherein the second guide includes a third guide surface defining the second conveyance path;
wherein the second guide is movable between:
a fifth position at which the second guide guides a sheet conveyed along the second conveyance path by the third guide surface; and
a sixth position at which the second guide opens the second conveyance path;
wherein the first conveyance-path guide and the second conveyance-path guide are temporarily positioned due to movement of the second guide from the sixth position to the fifth position; and
wherein the slider is configured to position the first conveyance-path guide and the second conveyance-path guide that are temporarily positioned.

8. The printing apparatus according to claim 6, further comprising:
a second guide; and
a tray,
wherein the second guide includes a third guide surface defining the second conveyance path;
wherein the second guide is movable between:
a fifth position at which the second guide guides a sheet conveyed along the second conveyance path by the third guide surface; and
a sixth position at which the second guide opens the second conveyance path; and
wherein the second guide is configured to, when the second guide is located at the sixth position, restrict attachment of the tray before the tray contacts the slider.

9. The printing apparatus according to claim 6, wherein the first conveyance-path guide and the second conveyance-path guide are assembled into a first guide;
wherein the first guide is movable between:
a third position at which the first guide guides a sheet conveyed along the first conveyance path by the first guide surface; and
a fourth position at which the first guide is moved downward from the third position; and
wherein the first guide is configured to restrict movement of the slider when the first guide is located at the fourth position.

10. The printing apparatus according to claim 1, wherein the slider includes a first cam surface and an other cam surface;
wherein, in a state where the slider is located at the first position, the first cam surface contacts the first conveyance-path guide to position the first conveyance-path guide, and the other cam surface contacts the second conveyance-path guide to position the second conveyance-path guide; and
wherein, in a state where the slider is located at the second position, the first cam surface separates from the first conveyance-path guide to release positioning of the first conveyance-path guide, and the other cam surface separates from the second conveyance-path guide to release positioning of the second conveyance-path guide.

11. A printing apparatus comprising:
a first guide including:
a first conveyance-path guide including a first guide surface defining a first conveyance path; and
a second conveyance-path guide configured to receive pressure from another member,
the first guide being movable between:
a guide position at which the first guide guides a sheet conveyed along the first conveyance path by the first guide surface; and
a non-guide position at which the first guide is moved from the guide position,
in a state where the first guide is located at the guide position, each of the first conveyance-path guide and the second conveyance-path guide is positioned.

12. The printing apparatus according to claim 11, wherein the first conveyance-path guide is disposed such that the first guide surface is displaceable downward relative to the second conveyance-path guide.

13. The printing apparatus according to claim 12, further comprising:
a print head;
a first restricting portion configured to, when the first guide is located at the guide position, contact the first conveyance-path guide and restrict movement of the first conveyance-path guide toward the print head; and
a second restricting portion configured to, when the first guide is located at the guide position, contact the first conveyance-path guide and restrict movement of the first conveyance-path guide away from the print head,
wherein the first conveyance-path guide includes:
a first member including the first guide surface and a first contact portion in contact with the first restricting portion;
a second member attached to the first member so as to be displaceable relative to the first member, the second member including a second contact portion in contact with the second restricting portion; and
a third member configured to urge the first member and the second member in directions away from each other.

14. The printing apparatus according to claim 12, further comprising:
a corrugated member configured to apply a corrugated shape to a sheet supported by the first guide surface, the corrugated shape undulating along a main scanning direction.

15. The printing apparatus according to claim 11, further comprising:
a frame configured to position the second conveyance-path guide.

16. The printing apparatus according to claim 11, wherein the second conveyance-path guide includes a second guide surface defining a second conveyance path, the second conveyance path being located below the first conveyance path.

17. The printing apparatus according to claim 16, further comprising a second guide,
wherein the second conveyance-path guide includes a pinch roller; and
wherein the second guide includes:
a third guide surface facing the second guide surface, the third guide surface defining the second conveyance path; and
a drive roller in contact with the pinch roller, the drive roller being configured to convey a sheet along the second conveyance path.

18. The printing apparatus according to claim 11, wherein the first conveyance-path guide includes a platen.

19. The printing apparatus according to claim 13, wherein the first restricting portion is a conveyance roller bearing that supports a conveyance roller configured to convey a sheet conveyed along the first conveyance path; and
wherein the first member is a platen.

20. The printing apparatus according to claim 19, wherein the second restricting portion is a slider movable between:
a first position at which the slider contacts and positions each of the first conveyance-path guide and the second conveyance-path guide; and
a second position at which the slider separates from the first conveyance-path guide and the second conveyance-path guide, and releases positioning of the first conveyance-path guide and the second conveyance-path guide; and
wherein the second member is a platen movable member attached to the platen so as to be displaceable relative to the platen.
